(19) United States
(12) Patent Application Publication
(10) Pub. No.: US 2026/0021689 A1
(43) Pub. Date: Jan. 22, 2026

(54) VEHICLE AIR CONDITIONING SYSTEM

(71) Applicant: NGK INSULATORS, LTD., Nagoya-City (JP)

(72) Inventor: Takafumi HAMADA, Nagoya-Shi (JP)

(73) Assignee: NGK INSULATORS, LTD., Nagoya-City (JP)

(21) Appl. No.: 19/186,808

(22) Filed: Apr. 23, 2025

(30) Foreign Application Priority Data
Jul. 19, 2024 (JP) 2024-116057

(51) Int. Cl. B60H 1/00

(52) U.S. Cl. CPC B60H 1/00564

(57) ABSTRACT

A vehicle air conditioning system includes: at least one air conditioning device 10 comprising an adsorption portion having an adsorbent configured to adsorb and separate moisture, and a heating means configured to heat the adsorption portion; an air conditioning duct for allowing air from a vehicle interior or a vehicle exterior to flow therethrough, the air conditioning duct having the air conditioning device provided therein, wherein the air conditioning duct has a first flow path and a second flow path; a valve configured to switch the flow of the air between the first flow path and the second flow path; and at least one waste heat recovery component provided between the air conditioning device and the valve. A distance between the air conditioning device and the waste heat recovery component is 5 to 200 mm.

### CROSS REFERENCE TO RELATED APPLICATIONS

This application claims the benefit of priority to Japanese Patent Application No 2024-116057 filed on Jul. 19, 2024 with the Japanese Patent Office, the entire contents of which are incorporated herein by reference in its entirety.

### FIELD OF THE INVENTION

The disclosure may relate to a vehicle air conditioning system.

### BACKGROUND OF THE INVENTION

In various types of vehicles such as automobiles, there are increasing requirements for improvement of vehicle interior environment. Specific requirements illustrate reduction of an amount of CO₂ in the vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

As a method for solving the above problems, a vehicle purifying system (vehicle air conditioning system) is proposed, which includes: a heater element (air conditioning device) including a honeycomb structure having an outer peripheral wall and partition walls provided on an inner side of the outer peripheral wall, the partition walls defining a plurality of cells each extending from one end face to other end face of the honeycomb structure to form a flow path, at least the partition wall being made of a material having a PTC property; a pair of electrodes comprising a first electrode provided on the one end face and a second electrode provided on the other end face; and a functional material-containing layer provided on a surface of each partition wall; as well as an inlet pipe communicating a vehicle interior with an inlet end face of the heater element; and an outflow pipe having a first path that communicates an outlet end face of the heater element with the vehicle interior, wherein the outflow pipe has a first path that communicates an outlet end face of the heater element with the vehicle interior and a second path that communicates the outlet end face of the heater element with a vehicle exterior, and wherein the system includes a switching valve configured to switch an air flow circulating through the outflow pipe between the first path and the second path.

During a regeneration process of an air conditioning device (a process for releasing water vapor, CO₂, and the like from a functional material-containing layer), the vehicle air conditioning system described in Patent Literature 1 applies a voltage to a pair of electrodes and heats the heater element to release water vapor, CO₂, and the like, and then the air containing the released substances is discharged through a second path in the outflow pipe to the vehicle exterior. Thus, the vehicle air conditioning system described in Patent Literature 1 discharges the heated air directly outside the vehicle during the regeneration process of the air conditioning device, which causes problems that the heat from the heated air is wasted and discarded, and the energy loss is significant. Also, the components provided downstream of the air conditioning device are exposed to the heated air during the regeneration process of the air conditioning device, and so they require heat resistant. Therefore, it is necessary to produce the components using expensive materials with heat resistance, which may increase the costs.

Therefore, a possible way to effectively utilize the heat generated during the regeneration process of the air conditioning devices is to place a waste heat recovery component on a downstream side of the air conditioning device. As the waste heat recovery component is placed to a position closer to the air conditioning device, the recovery efficient of heat generated during the regeneration process of the air conditioning device can be more improved. However, if the waste heat recovery component is close to the air conditioning device, the condensed water generated by cooling in the waste heat recovery component will easily adhere to the air conditioning device, which may cause functional degradation or failure (e.g., short circuit or increased electrical resistance) of the air conditioning device.

The disclosure was made to solve the problems as described above. An object of the disclosure is to provide a vehicle air conditioning system that can prevent condensed water from adhering to the air conditioning device while increasing a recovery efficiency of heat generated during the regeneration process of the air conditioning device.

### PRIOR ART

### Patent Literature

[Patent Literature 1] WO 2023/074202 A1

### SUMMARY OF THE INVENTION

As results of intensive studies on vehicle air conditioning systems including air conditioning devices, the present inventors have found that the above problems can be solved by placing a heat recovery component at a certain interval on a downstream side of an air conditioning device, and have completed one or more embodiments of the disclosure. In other words, the embodiments are exemplified as follows:
<1> A vehicle air conditioning system, which may include:
at least one air conditioning device comprising an adsorption portion having an adsorbent configured to adsorb and separate moisture, and a heating means configured to heat the adsorption portion;
   an air conditioning duct for allowing air from a vehicle interior or a vehicle exterior to flow therethrough, the air conditioning duct having the air conditioning device provided therein, wherein the air conditioning duct has a first flow path for allowing the air to flow into the vehicle interior on a downstream side of the air conditioning device and a second flow path for discharging the air to the vehicle exterior;
   a valve configured to switch the flow of the air between the first flow path and the second flow path; and
   at least one waste heat recovery component provided between the air conditioning device and the valve,
   wherein a distance between the air conditioning device and the waste heat recovery component is 5 to 200 mm.
<2> The vehicle air conditioning system according to <1>, wherein the distance between the air conditioning device and the waste heat recovery component may be 8 to 190 mm.
<3> The vehicle air conditioning system according to <1>or <2>, wherein the waste heat recovery component may be provided over the entire flow path cross section of the air conditioning duct
<4> The vehicle air conditioning system according to any one of <1>to <3>, wherein the vehicle air conditioning system may further include a heat pump cycle in the first flow path, the heat pump cycle comprising: a condenser for exchanging heat between warm heat of a refrigerant and the air; and an evaporator for exchanging heat between cold heat of the refrigerant and the air, and the waste heat recovery component may be a heat exchanger that exchanges heat between the heat of the refrigerant in the heat pump cycle and the air flowing through the second flow path.
<5> The vehicle air conditioning system according to any one of <1>to <3>, wherein the waste heat recovery component may be a heat storage structure, the heat storage structure comprising a honeycomb structure having: an outer peripheral wall and partition walls provided on an inner side of the outer peripheral wall, the partition walls defining a plurality of cells, each of the cells extending from a first end face to a second end face to the honeycomb structure; and a heat storage material contained in at least part of the cells.
<6> The vehicle air conditioning system according to any one of <1>to <5>, wherein the adsorbent may be configured to adsorb and separate at least one of carbon dioxide and volatile components.
<7> The vehicle air conditioning system according to any one of <1>to <6>, wherein the air conditioning device may include:
   a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air;
   an adsorbing layer comprising the adsorbent, the adsorbing layer being provided on a surface of each of the partition walls; and
   a pair of electrodes provided on the first end face and the second end face of the honeycomb structure, or on the outer peripheral wall parallel to the extending direction of the cells of the honeycomb structure.
<8> The vehicle air conditioning system according to <7>, which may further include a power source for applying a voltage to the pair of electrodes.
<9> The vehicle air conditioning system according to <7>or <8>, wherein at least the partition walls of the honeycomb structure may be made of a material having a PTC property.
<10> The vehicle air conditioning system according to any one of <1>to <6>, which may further include a control unit for controlling the air conditioning device and the valve,
   wherein the control unit may be configured to perform an air conditioning mode configured to switch the valve so that the air flows into the first flow path, and a regeneration mode configured to heat the air conditioning device and switch the valve so that the air flows into the second flow path.

### BRIEF DESCRIPTION OF THE DRAWINGS

FIG. 1 is an overall schematic configuration view of a vehicle air conditioning system according to an embodiment of the disclosure;

FIG. 2A is a schematic view of a cross section of a typical air conditioning device used in a vehicle air conditioning system according to an embodiment of the disclosure, which is parallel to a flow path direction;

FIG. 2B is a schematic cross-sectional view of the air conditioning device in FIG. 2A taken along the line a-a′;

FIG. 3 is an overall schematic configuration view of a vehicle air conditioning system where the waste heat recovery component is a heat exchanger;

FIG. 4A is a schematic view of a cross section of a typical heat storage structure used in a vehicle air conditioning system according to an embodiment of the disclosure, which is parallel to a flow path direction; and

FIG. 4B is a schematic cross-sectional view of the heat storage structure taken along the line b-b′ in FIG. 2A.

### DETAILED DESCRIPTION OF THE INVENTION

A vehicle air conditioning system according to the disclosure may include: at least one air conditioning device including an adsorption portion having an adsorbent configured to adsorb and separate moisture, and a heating means configured to heat the adsorption portion; an air conditioning duct for allowing air from a vehicle interior or a vehicle exterior to flow therethrough, the air conditioning duct having the air conditioning device provided therein, wherein the air conditioning duct has a first flow path for allowing the air to flow into the vehicle interior on a downstream side of the air conditioning device and a second flow path for discharging the air to the vehicle exterior; a valve configured to switch the flow of the air between the first flow path and the second flow path; and at least one waste heat recovery component provided between the air conditioning device and the valve. A distance between the air conditioning device and the waste heat recovery component may be 5 to 200 mm. According to such configuration, the vehicle air conditioning system can prevent condensed water from adhering to the air conditioning device while improving a recovery efficiency of heat generated during a regeneration process of the air conditioning device. Therefore, the heat generated during the regeneration process of the air conditioning device can be effectively utilized, and components provided on the downstream side of the air conditioning device can be produced using inexpensive materials that do not require heat resistance. The condensed water is also difficult to adhere easily to the air conditioning device, and it can, therefore, suppress functional degradation and failure of the air conditioning device (e.g., short circuit between electrodes, increased electrical resistance and the like).

Hereinafter, embodiments of the invention will be specifically described with reference to the drawings. It should be understood that the invention is not limited to the following embodiments, and those which have appropriately added changes, improvements and the like to the following embodiments based on knowledge of a person skilled in the art without departing from the spirit of the invention fall within the scope of the invention.

The vehicle air conditioning system according to an embodiment can be suitably utilized for various vehicles such as automobiles. The vehicle includes, but not limited to, automobiles and electric rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. In particular, the vehicle air conditioning system according to an embodiment can be suitably used for a vehicle that has no internal combustion engine such as electric vehicles and electric rail cars.

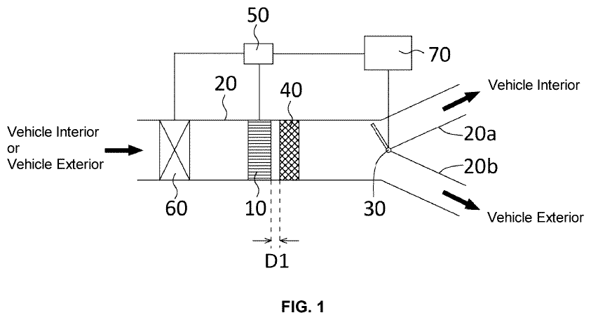

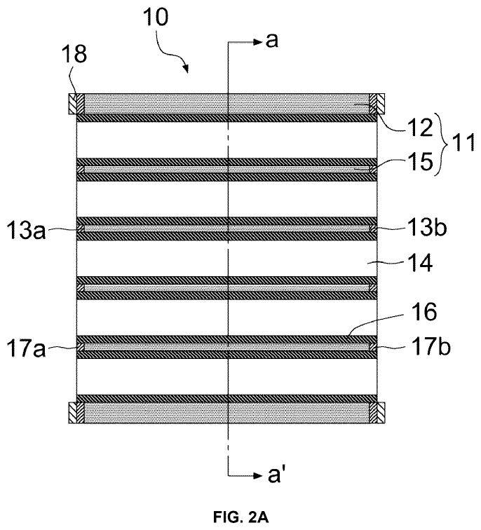

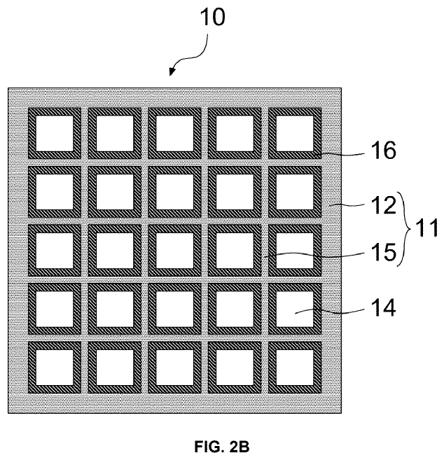

FIG. 1 is an overall schematic configuration view of a vehicle air conditioning system according to an embodiment of the disclosure. FIG. 2A is a schematic view of a cross section of a typical air conditioning device used in a vehicle air conditioning system according to an embodiment of the disclosure, which is parallel to a flow path direction; FIG. 2B is a schematic cross-sectional view of the air conditioning device in FIG. 2A taken along the line a-a′.

As illustrated in FIG. 1, a vehicle air conditioning system according to an embodiment includes: an air conditioning device 10; an air conditioning duct 20; a valve 30; and a waste heat recovery component 30. Further, the vehicle air conditioning system can further include: a power source 50; a ventilation fan 60; and a control unit 70.

The air conditioning device 10 includes an adsorption portion having an adsorbent configured to adsorb and separate the moisture, and a heating means configured to heat the adsorption portion.

The air conditioning duct 20 can allow the air from the vehicle interior or the vehicle exterior to flow therethrough, and has the air conditioning device 30 provided therein. The air conditioning duct 20 can have, on a downstream side of the air conditioning device 10, a first flow path 20a that allows the air to flow into the vehicle interior, and a second flow path 20b that allows the air to be discharged to the vehicle exterior.

The valve 30 may be configured to switch the flow of the air between the first flow path 20a and the second flow path 20b.

The waste heat recovery component 40 is provided between the air conditioning device 10 and the valve 30.

In the vehicle air conditioning system having the above structure, when the air from the vehicle interior or vehicle exterior flows into the air conditioning device 20 through the air conditioning duct 20, the adsorption or separation of the moisture (water vapor) can be performed in the air conditioning device 10. When the moisture is adsorbed in the air conditioning device 10, then it should be an adsorption mode (air conditioning mode) that does not activate the heating means of the air conditioning device 10. The air that has reduced or removed the moisture in the air conditioning device 10 (adsorption portion) can be allowed to flow into the vehicle interior by switching the valve 30 so that it flows into the first flow path 20a. On the other hand, when separating the moisture in the air conditioning device 10, then it should be a separation mode (regeneration mode) that activates the heating means of the air conditioning device 10, so that the adsorption portion is heated. The air containing the moisture separated from the air conditioning device 10 (adsorption portion) can be discharged to the vehicle exterior by switching the valve 30 so that it flows into the second flow path 20b after the heat is recovered in the waste heat recovery component 40. Therefore, the heat generated during the regeneration process of the air conditioning device 10 can be effectively recovered by the waste heat recovery component 40.

A distance D1 between the air conditioning device 10 and the waste heat recovery component 40 is 5 to 200 mm. The distance D1 between the air conditioning device 10 and the waste heat recovery component 40 of 200 mm or less can increase a recovery efficiency of the heat generated during the regeneration process in the waste heat recovery component 40. The distance D1 between the air conditioning device 10 and the waste heat recovery component 40 of 5 mm or more can make it difficult for the condensed water to adhere to the air conditioning device 10, thus suppressing functional degradation and failure of the air conditioning device 10 (e.g., short circuit between electrodes, increased electrical resistance and the like). For example, as electrical resistance increases, the power used to heat the adsorption portion decreases, resulting in insufficient separation of the moisture in the separation mode and a decreased amount of the moisture adsorbed in the adsorption mode. From the viewpoint of stable suppression of such problems, the distance D1 between the air conditioning device 10 and the waste heat recovery component 40 is preferably 8 to 190 mm.

The waste heat recovery component 40 may be provided in a part of a region of a flow path cross section of the air conditioning duct 20, but it is preferably provided over the entire flow path cross section of the air conditioning duct 20. By placing the waste heat recovery component 40 in this manner, the recovery efficiency of the heat generated during the regeneration process can be increased. Further, the components of the waste heat recovery component 40 on the downstream side are difficult to be exposed to hot air, so that the deterioration of those components can be suppressed, and those components made of inexpensive materials can be used.

Each component of the vehicle air conditioning system will be described below in detail.

### 1. Air Conditioning Device 10

The air conditioning device 10 is not particularly limited as long as it includes an adsorption portion having an adsorbent configured to adsorb and separate moisture and a heating means configured to heat the adsorption portion.

Also, the number of air conditioning devices 10 provided in the air conditioning duct 20 may be one or more than one. When more than one air conditioning devices 10 are provided, they may be arranged in parallel to or in series with the flow of the air flowing through the air conditioning duct 20.

FIG. 2A is a schematic view of a cross section of a typical air conditioning device used in a vehicle air conditioning system according to an embodiment, which is parallel to a flow path direction; FIG. 2B is a schematic cross-sectional view of the air conditioning device in FIG. 2A taken along the line a-a′.

The air conditioning device 10 as illustrated in FIGS. 2A and 2B includes: a honeycomb structure 11 having an outer peripheral wall 12 and partition walls 15 provided on an inner side of the outer peripheral wall 12, the partition walls 15 defining a plurality of cells 14 each extending from a first end face 13a to a second end face 13b of the honeycomb structure 11 to form a flow path for air; an adsorbing layer 16 containing an adsorbent, the adsorbing layer 16 being provided on a surface of each of the partition walls 15; and a pair of electrodes 17a, 17b provided on the first end face 13a and the second end face 13b of the honeycomb structure 11. Although not illustrated, the pair of electrodes 17a, 17b may be provided on the outer peripheral wall 12 parallel to the extending direction of the cells 14 of the honeycomb structure 11. Also, Terminals 18 may be connected to the pair of electrodes 17a, 17b, respectively.

### 1-1. Honeycomb Structure 11

The shape of the honeycomb structure 11 is not particularly limited. For example, an outer shape of a cross section of the honeycomb structure 11 orthogonal to the flow path direction (extending direction of the cells 14) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 13a and second end face 13b) have the same shape as the cross section. Also, when the cross section and the end faces are polygonal, the corners may be chamfered.

The shape of each cell 14 is not particularly limited, but it may be polygonal such as quadrangular, pentagonal, hexagonal, heptagonal, and octagonal, circular, or oval in the cross section of the honeycomb structure 11 orthogonal to the flow path direction. These shapes may be alone or in combination of two or more. Moreover, among these shapes, the quadrangle or the hexagon is preferable. By providing the cells 14 having such a shape, it is possible to reduce the pressure loss when the air flows.

The honeycomb structure 11 may be a honeycomb joined body that includes a plurality of honeycomb segments and joining layers that join outer peripheral side surfaces of the plurality of honeycomb segments together. The use of the honeycomb joined body can increase the total cross-sectional area of the cells 14, which is important for ensuring the flow rate (flow velocity) of the air, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer peripheral wall 12 and the partition walls 15. In addition to the role of joining the honeycomb segments to each other, the joining material can also be used as an outer peripheral coating material after joining the honeycomb segments.

From the viewpoints of ensuring the strength of the honeycomb structure 11, reducing a pressure loss when the air passes through the cells 14, ensuring the amount of the adsorbent supported, and ensuring the contact area with the air flowing inside the cells 14, it is desirable to suitably combine a thickness of the partition wall 15, a cell density, and a cell pitch (or an opening ratio of the cells 14).

As used herein, the cell density refers to a value obtained by dividing a number of cells by an area of one end face (first end face 13a or second end face 13b) of the honeycomb structure 11 (the total area of the partition walls 15 and the cells 14 excluding the outer peripheral wall 12).

As used herein, the cell pitch refers to a value obtained by the following calculation. First, the area of one end face (first end face 13a or second end face 13b) of the honeycomb structure 11 (the total area of the partition walls 15 and the cells 14 excluding the outer peripheral wall 12) is divided by the number of the cells to calculate an area per a cell. A square root of the area per a cell is then calculated, and this is determined to be the cell pitch.

As used herein, the opening ratio of the cells 14 refers a value obtained by dividing the total area of the cells 14 defined by the partition walls 15 by the area of one end face (first end face 13a or second end face 13b) (the total area of the partition walls 15 and the cells 14 excluding the outer peripheral wall 12) in the cross section orthogonal to the flow path direction of the honeycomb structure 11. It should be noted that when calculating the opening ratio of the cells 14, the pair of electrodes 17a, 17b, and the adsorbing layer 16 are not taken into account.

In an embodiment that is advantageous from the viewpoint of supporting a sufficient amount of functional material, the thickness of the partition walls 15 is 0.300 mm or less, the cell density is 100 cells/cm² or less, and the cell pitch is 1.0 mm or more. In a preferred embodiment, the thickness of the partition walls 15 is 0.200 mm or less, the cell density is 70 cells/cm² or less, and the cell pitch is 1.2 mm or more. In a more preferred embodiment, the thickness of the partition walls 15 is 0.130 mm or less, the cell density is 65 cells/cm² or less, and the cell pitch is 1.3 mm or more.

From the viewpoints of ensuring the strength of the honeycomb structure 11 and maintaining lower electrical resistance, the lower limit of the thickness of the partition wall 15 is preferably 0.010 mm or more, more preferably 0.020 mm or more, and even more preferably 0.030 mm or more.

From the viewpoints of ensuring the strength of the honeycomb structure 11, maintaining lower electrical resistance, and increasing a surface area to facilitate reaction, adsorption, and separation, the lower limit of the cell density is 30 cells/cm² or more, and preferably 35 cells/cm² or more, and even more preferably 40 cells/cm² or more.

From the viewpoints of ensuring the strength of the honeycomb structure 11, maintaining lower electrical resistance and increasing a surface area to facilitate reaction, adsorption and separation, the upper limit of the cell pitch is 2.0 mm or less, more preferably 1.8 mm or less, and even more preferably 1.6 mm or less.

In an embodiment that is advantageous in terms of both reducing pressure loss and maintaining strength, the thickness of the partition walls 15 is 0.08 to 0.36 mm, the cell density is 2.54 to 140 cells/cm², and the opening ratio of the cells 14 is 0.70 or more. In a preferred embodiment, the thickness of the partition walls 15 is 0.09 to 0.35 mm, the cell density is 15 to 100 cells/cm², and the opening ratio of the cells 14 is 0.80 or more. In a more preferred embodiment, the thickness of the partition walls 15 is 0.14 to 0.30 mm, the cell density is 20 to 90 cells/cm², and the opening ratio of the cells 14 is 0.85 or more.

From the viewpoint of ensuring the strength of the honeycomb structure 11, the upper limit of the opening ratio of the cells 14 is preferably 0.94 or less, more preferably 0.92 or less, and even more preferably 0.90 or less.

Although the thickness of the outer peripheral wall 12 is not particularly limited, it is preferably determined based on the following considerations. First, from the viewpoint of reinforcing the honeycomb structure 11, the thickness of the outer peripheral wall 12 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer peripheral wall 12 is preferably 1.0 mm or less, more preferably 0.5 mm, even more preferably 0.4 mm or less, and still more preferably 0.3 mm or less.

As used herein, the thickness of the outer peripheral wall 12 refers to a length, in a normal line direction of a side surface of the honeycomb structure 11, from a boundary between the outer peripheral wall 12 and the outermost cell 14 or the partition wall 15 to the side surface of the honeycomb structure 11 in the cross section orthogonal to the flow path direction of the honeycomb structure 11.

The length of the honeycomb structure 11 in the flow path direction and the cross-sectional area of the honeycomb structure 11 orthogonal to the flow path direction may be adjusted according to the required size of the air conditioning device 10, and are not particularly limited. For example, when used in a compact air conditioning device 10 while ensuring a predetermined function, the honeycomb structure 11 can have a length of 2 to 20 mm in the flow path direction and have a cross-sectional area of 10 cm² or more orthogonal to the flow path direction. Although the upper limit of the cross-sectional area orthogonal to the flow path direction is not particularly limited, it is, for example, 300 cm² or less.

The partition walls 15 forming the honeycomb structure 11 are preferably made of a material that can be heated by electric conduction, specifically made of a material having a PTC property. Further, the outer peripheral wall 12 may also be made of a material having a PTC property, as with the partition walls 15, as needed. By such a configuration, the adsorbing layer 16 can be directly heated by heat transfer from the heat-generating partition walls 15 (and optionally the outer peripheral wall 12). Further, the material having the PTC property has characteristics such that when the temperature increases to exceed the Curie point, the resistance value is sharply increased, making it difficult for electricity to flow. Therefore, when the temperature of the partition walls 15 (and the outer peripheral wall 12 if necessary) becomes high, the current flowing through them is limited, thereby suppressing excessive heat generation of the honeycomb structure 11. Therefore, it is possible to suppress thermal deterioration of the adsorbing layer 16 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 30 Ω·cm or less, and more preferably 18 Ω·cm or less, and even more preferably 16 Ω·cm or less. As used herein, the volume resistivity at 25° C. of the material having the PTC property is measured according to J IS K 6271:2008.

From the viewpoints of creating a device that can be heated by electric conduction and have the PTC property, the outer peripheral wall 12 and the partition walls 15 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component. However, it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

In terms of reduction of the environmental load, it is desirable that the materials used for the outer peripheral wall 12 and the partition walls 15 are substantially free of lead (Pb). Specifically, the outer peripheral wall 12 and the partition walls 15 preferably have a Pb content of 0.01% by mass or less, and more preferably 0.001% by mass or less, and still more preferably 0% by mass. The lower Pb content can allow the air heated by contact with the heat-generating partition walls 15 or the like to be safely applied to organisms such as humans, for example. In the outer peripheral wall 12 and the partition walls 15, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

The Curie point of the material making up the outer peripheral wall 12 and the partition walls 15 is preferably in a temperature range where the resistance value is twice or more the resistance at room temperature (25° C.). If the Curie point is in such a temperature range, the current flowing through the air conditioning device 10 will be limited when the temperature of the air conditioning device 10 becomes high, so that any excessive heat generation of the air conditioning device 20 will be efficiently suppressed. Therefore, thermal deterioration of the adsorbing layer 16 caused by excessive heat generation can be suppressed.

In terms of efficiently heating the adsorbing layer 16, the material making up the outer peripheral wall 12 and the partition walls 15 preferably have a lower limit of a Curie point of 80° C. or more, more preferably 100° C. or more, even more preferably 110° C. or more, and still more preferably 125° C. or more. Further, in terms of safety as a component placed in the vehicle interior or near the vehicle interior, the upper limit of the Curie point is preferably 200° C. or more, more preferably 190° C. or more, even more preferably 180° C. or more, and still more preferably 150° C. or more.

The Curie point of the material making up the outer peripheral wall 12 and the partition walls 15 can be adjusted by the type and amount of shifter added. For example, the Curie point of barium titanate (BaTiO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC). A change in electrical resistance of the sample as a function of a temperature when the temperature is increased from 10° C. is measured using a DC resistance meter (e.g., Multimeter 3478A, from JAPAN HEWLETT PACKARD, LLC). Based on an electrical resistance-temperature plot obtained by the measurement, a temperature at which the resistance value is twice the resistance value at room temperature (25° C.) is defined as the Curie point.

### 1-2. Adsorbing Layer 16

The adsorbing layer 16 contains an adsorbent

The adsorbing layer 16 can be provided on the surfaces of the partition walls 15 (in the case of the outermost cells 14, the partition walls 15 that define the outermost cells 14 and the outer peripheral wall 12). By thus providing the adsorbing layer 16, the moisture, CO₂ and the like are easily adsorbed during the adsorption mode, and the adsorbing layer 16 can be easily heated during the separation mode, so that the substances to be adsorbed are easily separated.

The temperature of the adsorbing layer 16 is preferably obtained by previously determining a relationship between at least one condition parameter and a temperature of the adsorbing layer 16, the at least one condition parameter being selected from the temperature of the honeycomb structure 11, the resistance value of the honeycomb structure 11, the current value of the honeycomb structure 11, the heating time of the honeycomb structure 11, the temperature of the air passing through the honeycomb structure 11, and the amount of the components contained in the air passing through the honeycomb structure 11, and then measuring the condition parameter. Although it is difficult to directly measure the temperature of the adsorbing layer 16 in the vehicle air conditioning system, the temperature of the adsorbing layer 16 can be determined by measuring the condition parameter as described above.

The adsorbent contained in the adsorbing layer 16 is capable of adsorbing and separating the moisture. Also, the adsorbent can preferably adsorb and separate one or more selected from carbon dioxide and volatile components, in addition to the moisture. By using such an adsorbent, it is possible to obtain effects of dehumidifying the air as well as purifying the air by the air conditioning device 10.

The adsorbent contained in the adsorbing layer 16 preferably has a function that can adsorb the moisture and the like at −20 to 60° C. and separate them at an elevated temperature of 60° C. or more.

Examples of the adsorbent include, but not limited to, aluminosilicate, silica gel, silica, graphene oxide, polymer adsorbents, polystyrene sulfonic acid, zeolite, activated carbon, alumina, low-crystalline clay, amorphous aluminum silicate composites, and metal organic frameworks (MOFs). These may be used alone or in combination of two or more.

Examples of the aluminosilicate that can be preferably used herein include AFI type-, CHA type-, or BEA type-zeolite; porous clay minerals such as allophane and imogolite. Also, it is more preferable that the aluminosilicate is amorphous.

As the silica gel, type A silica gel is preferably used.

Examples of the polymer adsorbent that can be preferably used herein include a polymer adsorbent having a polyacrylic acid polymer chain. For example, sodium polyacrylate or the like can be used as the polymer adsorbent.

The metal organic framework is a crystalline hybrid material containing metal ions and organic molecules (organic ligands). The metal ions are preferably hydrophilic metal ions (for example, aluminum ions).

The volatile components in the air in the vehicle interior are, for example, volatile organic compounds (VOCs) and odor components other than the VOCs.

Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The adsorbing layer 16 can further contain a catalyst. By containing the catalyst, it is possible to promote oxidation-reduction reaction and the like to purify carbon dioxide and/or volatile components. The catalyst having such a function includes metal catalysts such as Pt, Pd and Ag, and oxide catalysts such as CeO₂ and ZrO₂. The catalyst may be used alone or in combination of two or more types. The catalyst may also be used in combination with the functional material as described above.

The thickness of the adsorbing layer 16 may be determined according to the size of the cells 14, and is not particularly limited. For example, from the viewpoint of ensuring sufficient contact with air, the thickness of the adsorbing layer 16 is preferably 20 μm or more, more preferably 25 μm or more, and even more preferably 30 μm or more. On the other hand, from the viewpoint of suppressing separation of the adsorbing layer 16 from the partition walls 15 and the outer peripheral wall 12, the thickness of the adsorbing layer 16 is preferably 400 μm or less, more preferably 380 μm or less, and even more preferably 350 μm or less.

The thickness of the adsorbing layer 16 is measured using the following procedure. Any cross section of the honeycomb structure 11 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the honeycomb structure 11. The thickness of each adsorbing layer 16 visually recognized from the cross-sectional image is calculated by dividing the cross-sectional area by the length of the cells 14 in the flow path direction. This calculation is performed for all the adsorbing layers 16 visually recognized from the cross-sectional image, and an average value thereof is determined to be the thickness of the adsorbing layer 16.

From the viewpoint of exerting a desired function in the air conditioning device 10, an amount of the adsorbing layer 16 is preferably 50 to 500 g/L, more preferably 100 to 400 g/L, and even more preferably 150 to 350 g/L, based on the volume of the honeycomb structure 11. It should be noted that the volume of the honeycomb structure 11 is a value determined by the external dimensions of the honeycomb structure 11.

### 1-3. Pair of Electrodes 17a, 17b

A pair of electrodes 17a, 17b may be provided on the first end face 13a and the second end face 13b of the honeycomb structure 11, respectively, as illustrated in FIG. 2A, although the positions of the electrodes 17a, 17b are not limited thereto. Also, the pair of electrodes 17a, 17b may be provided on the outer peripheral wall 12 parallel to the extending direction of the cells 14 of the honeycomb structure 11.

Applying a voltage between the pair of electrodes 17a, 17b allows the honeycomb structure 11 to generate heat by Joule heat

The pair of electrodes 17a, 17b may employ, for example, a metal or alloy containing at least one selected from Cu, Ag, Al, Ni and Si, although not particularly limited thereto. It is also possible to use an ohmic electrode capable of ohmic contact with the outer peripheral wall 12 and/or the partition walls 15 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 17a, 17b may have a single-layer structure, or may have a laminated structure of two or more layers. When the pair of electrodes 17a, 17b have the laminated structure of two or more layers, the materials of the respective layers may be of the same type or of different types.

The thickness of the pair of electrodes 17a, 17b may be appropriately set according to the method for forming the pair of electrodes 17a, 17b. The method for forming the pair of electrodes 17a, 17b includes metal deposition methods such as sputtering, vapor deposition, electrolytic deposition, and chemical deposition. Alternatively, the pair of electrodes 17a, 17b can be formed by applying an electrode paste and then baking it, or by thermal spraying. Furthermore, the pair of electrodes 17a, 17b may be formed by joining metal sheets or alloy sheets.

Each of the thicknesses of the pair of electrodes 17a, 17b is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### 1-4. Terminal 18

The terminals 18 are connected to the pair of electrodes 17a, 17b, and provided on at least part of the pair of electrodes 17a, 17b. The provision of the terminals 18 facilitates connection to an external power supply. The terminals 18 are connected to a conductor connected to the external power supply.

The terminals 18 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

The size and shape of the terminal 18 are not particularly limited. For example, as illustrated in FIG. 2A, the terminals 18 can be provided on the whole of the pair of electrodes 17a, 17b on the outer peripheral wall 12. Further, the terminals 18 may be provided on a part of the pair of electrodes 17a, 17b on the outer peripheral wall 12, or may be provided so as to extend toward an outer side than the outer edge of each of the pair of electrodes 17a, 17b on the outer peripheral wall 12. Further, the terminals 18 may be provided on a part of the pair of electrodes 17a, 17b on the partition walls 15, or may be provided so as to block a part of the cells 14.

Furthermore, the thickness of the terminal 18 is not particularly limited, but it is, for example, 0.01 to 10 mm, typically 0.05 to 5 mm.

The method of connecting the terminals 18 to the pair of electrodes 17a, 17b is not particularly limited as long as they are electrically connected. For example, they can be connected by diffusion bonding, a mechanical pressing mechanism, welding, or the like.

### 1-5. Method for Producing Air Conditioning Device 10

The method for producing the air conditioning device 10 according to the embodiment of the disclosure is not particularly limited, and it can be performed according to a known method. Hereinafter, the method for producing the air conditioning device 10 according to an embodiment of the disclosure will be illustratively described.

A method for producing the honeycomb structure 11 forming the air conditioning device 10 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 11 containing, as a main component, BaTiO₃-based crystal particles in which a part of Ba is substituted with the rare earth element.

Further, maintaining the temperature of the honeycomb formed body of 1150 to 1250° C. can allow the Ba₂TiO₄ crystal particles generated in the firing process to be easily removed, so that the honeycomb structure 11 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 11.

The amount of time when the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. Maintaining the honeycomb formed body at 900 to 950° C. for 0.5 to 5 hours can lead to sufficient decomposition of BaCO₃, so that a honeycomb structure 11 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost

A firing furnace used in the firing step and the degreasing step is not particularly limited, but it may be an electric furnace, a gas furnace, or the like.

The pair of electrodes 17a, 17b is formed on the honeycomb structure 11 thus obtained. The pair of electrodes 17a, 17b can be formed by metal deposition methods such as sputtering, vapor deposition, electrolytic deposition, and chemical deposition. Further, the pair of electrodes 17a, 17b can also be formed by applying an electrode paste and then baking it. Furthermore, the pair of electrodes 17a, 17b can also be formed by thermal spraying. The pair of electrodes 17a, 17b may be composed of a single layer, but may also be composed of a plurality of electrode layers having different compositions. A typical method for forming the pair of electrodes 17a, 17b will be described below.

First, an electrode slurry containing an electrode material, an organic binder, and a dispersion medium is prepared, and the first end face 13a or the second end face 13b of the honeycomb structure 11 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 11 is removed by blowing and wiping. The slurry can be then dried to form the pair of electrodes 17a, 17b on the first end face 13a or the second end face 13b of the honeycomb structure 11. The drying can be performed while heating the honeycomb structure 11 to a temperature of about 120 to 600° C., for example. Although a series of steps of coating, slurry removal, and drying may be performed only once, the steps can be repeated multiple times to provide the pair of electrodes 17a, 17b having desired thicknesses.

The terminals 18 are then provided at predetermined positions of the pair of electrodes 17a, 17b, and the pair of electrodes 17a, 17b and the terminals 18 are connected to each other. As a method of connecting the pair of electrodes 17a, 17b to the terminals 18, the method described above can be used. It should be noted that the terminals 18 may be placed after forming an adsorbing layer 16 described below.

The adsorbing layer 16 is then formed on the surfaces of the partition walls 15 and the like of the honeycomb structure 11.

Although the method for forming the adsorbing layer 16 is not particularly limited, it can be formed, for example, by the following steps. The honeycomb structure 11 is immersed in a slurry containing an adsorbent, a binder, and a dispersion medium for a predetermined period of time, and an excess slurry on the end faces and the outer periphery of the honeycomb structure 11 is removed by blowing and wiping. The binder may be an organic binder or an inorganic binder, or a combination thereof. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the adsorbing layer 16 on the surfaces of the partition walls 15 and the like. The drying can be performed while heating the honeycomb structure 11 to a temperature of about 120 to 600° C., for example. Although a series of steps of immersion, slurry removal, and drying may be performed only once, the steps can be repeated multiple times to provide the adsorbing layer 16 having the desired thickness on the surfaces of the partition walls 15 and the like.

### 2. Air Conditioning Duct 20

The air conditioning duct 20 is a flow path that can allow the air from the vehicle interior or the vehicle exterior to flow therethrough. The upstream side of the air conditioning duct 20 is connected to the vehicle interior or an outside air introduction port. The air conditioning duct 20 allows the air from the vehicle interior or vehicle exterior to flow therein, and also allows the air that has passed through the air conditioning device 10 to flow in the vehicle interior or flow out to the vehicle exterior. Therefore, the air conditioning duct 20 can have a structure that branches into a first flow path 20 that allows the air to flow into the vehicle interior on the downstream side of the air conditioning device 10, and a second flow path 20b that allows the air to be discharged to the vehicle exterior.

The size of the air conditioning duct 20 (at a portion where the air conditioning device 10 is provided) is not limited, but the inner circumference length of the cross section of the air conditioning duct 20 is, for example, 10 to 100 cm. The inner circumferential length of the cross section of each of the first flow path 20a and the second flow path 20b is, for example, 3 to 97 cm.

### 3. Valve 30

The valve 30 may be configured to switch the flow of the air between the first flow path 20a and the second flow path 20b. The valve 30 can be provided at a branch portion between the first flow path 20a and the second flow path 12b in the air conditioning duct 20.

The valve 30 is not particularly limited as long as it is electrically driven and has the function of switching the flow path, and a solenoid valve, an electric valve, and the like can be used. For example, the valve 30 includes an opening/closing door supported by a rotating shaft and an actuator such as a motor that rotates the rotating shaft. The actuator can be configured to be controllable by the control unit 70.

### 4. Waste Heat Recovery Component 40

The waste heat recovery component 40 is a component for recovering the heat generated during the regeneration process of the air conditioning device 10. The waste heat recovery component 40 is provided between the air conditioning device 10 and the valve 30.

The waste heat recovery component 40 is not particularly limited as long as it can recover heat, and a heat exchanger such as a heat sink, a heat storage structure, or the like can be used.

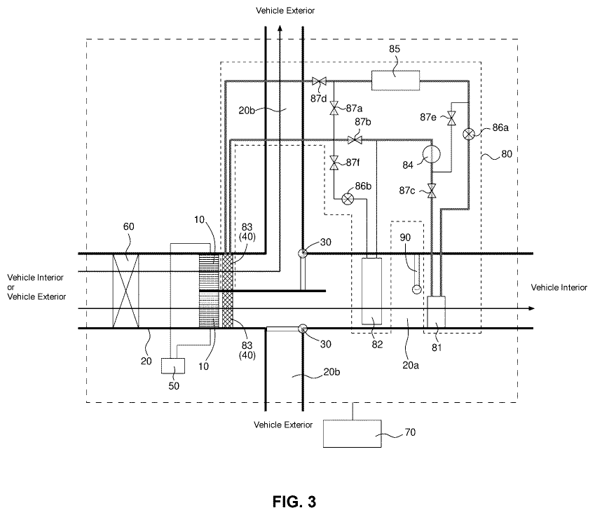

Here, the overall schematic view of the vehicle air conditioning system where the waste heat recovery component 40 is the heat exchanger is illustrated in FIG. 3.

In the vehicle air conditioning system depicted in FIG. 3, the air conditioning duct 20 branches into two portions, and the air conditioning device 10 and the waste heat recovery component 40 are provided in the two branching flow paths, respectively. The number of branching flow paths is not limited to two, but it may be three or more.

The vehicle air conditioning system illustrated in FIG. 3 further includes a heat pump cycle 80 in which a condenser 81 for exchanging heat between the warm heat of the refrigerant and the air and an evaporator 82 for exchanging heat between the cold heat of the refrigerant and the air are provided in the first flow path 20a. Further, the vehicle air conditioning system can further include an air mix door 90. In this vehicle air conditioning system, the waste heat recovery component 40 is a heat exchanger 83 that exchanges heat between the heat of the refrigerant in the heat pump cycle 80 and the air flowing through the second flow path 20b. The condenser 81 can dissipate the heat by a high-temperature, low pressure refrigerant flowing therethrough, and can heat the air passing around the condenser 81. The evaporator 82 can absorb the heat by a low-temperature, low-pressure refrigerant flowing therethrough, and can cool the air passing around the evaporator 82. The heat exchanger 83 can absorb the heat from the heated air using the refrigerant that flows therethrough, mainly when executing the heating operation mode, and can increase the temperature of the refrigerant by absorbing the heat from the air.

It should be noted that FIG. 3 illustrates only one heat exchanger 83 being connected to the heat pump cycle 80 for the sake of simplicity of the drawing, but the other heat exchanger 83 is also connected to the heat pump cycle 80 as with the former heat exchanger 83.

The heat pump cycle 80 can further include, in addition to the condenser 81, the evaporator 82 and the heat exchanger 83, a compressor 84; an outdoor heat exchanger 85; expansion valves 35a, 86b; and shutoff valves 87a to 87f, and each of these members is connected via the refrigerant flow path.

The compressor 84 has a function of compressing and discharging the refrigerant. The compressor 84 has a suction portion connected to the outdoor heat exchanger 34 and the heat exchanger 83, and a discharge portion connected to the condenser 81, via the refrigerant flow path, respectively. The compressor 84 is driven by the control unit 70 and discharges the high-temperature, high-pressure refrigerant to the condenser 81 by compressing the refrigerant

It should be noted that a known device such as a gas-liquid separator may be provided between the compressor 84 and the outdoor heat exchanger 83.

The outdoor heat exchanger 85 has a function of performing heat exchange between the heat of the refrigerant and the outside air. The outdoor heat exchanger 85 can absorb the heat from the outside air using a low-temperature, low-pressure refrigerant flowing therethrough, mainly when executing the heating operation mode, and can vaporize the refrigerant by absorbing the heat from the outside air. Moreover, the outdoor heat exchanger 85 can release the heat to the outside air by the high-temperature, high-pressure refrigerant flowing therethrough, and cools the refrigerant by releasing the heat to the outside air, mainly when executing the cooling operation mode.

The expansion valves 86a, 86b are throttle valves whose opening degrees can be adjusted by the control unit 70. In particular, when the heating operation mode is executed, the expansion valve 86a reduces the pressure of the refrigerant discharged from the condenser 81 to expand it, and then discharges the low-temperature, low-pressure refrigerant to the outdoor heat exchanger 85. Furthermore, when the cooling operation mode is executed, the expansion valve 86b reduces the pressure of the refrigerant from the outdoor heat exchanger 85 to expand it, and then discharge the low-temperature, low-pressure refrigerant to the evaporator 82.

The shutoff valves 87a to 87f are provided to control the flow path of the refrigerant. The opening and closing of the shutoff valves 87a to 87f are controlled by the control unit 70.

The air mix door 90 is configured to rotate in the air conditioning duct 20 between a heating position that opens a heating path toward the condenser 81 and a cooling position that opens a cooling path that bypasses the condenser 81. Furthermore, by rotating the air mix door 90 between the heating position and the cooling position, it can adjust a ratio of the air passing through the condenser 81 to the air bypassing the condenser 81, thereby adjusting the temperature of the air flowing into the vehicle interior.

In the vehicle air conditioning system illustrated in FIG. 3, the execution modes of the air conditioning device 10 can include a dehumidification mode, regeneration mode, and dehumidification-regeneration mode. The operation mode of the air conditioning device 10 can be selected according to switch operations by the driver, changes in humidity detected by various detection units, and the like.

The dehumidification mode can be dehumidified by switching the valve 30 so that the air is allowed to flow into the flow path 20a in all the branching flow paths to circulates the air through the air conditioning device 10. By performing the dehumidification mode, the air from the vehicle interior or the vehicle exterior can be rapidly dehumidified.

The regeneration mode regenerates the adsorbing portion by switching the valve 30 so that the air is allowed to flow out to the second flow path 20b at all the branching flow paths to circulating the air while heating the air conditioning device 10. By performing such a regeneration mode, the regeneration of the adsorbing portion of the air conditioning device 10 can be rapidly performed.

In the dehumidification and regeneration modes, as illustrated in FIG. 3, the adsorbing portion is regenerated by switching the valve 30 to allow the air to flow into the first flow path 20a in one branching flow path to dehumidify it, and switching the valve 30 to allow the air to flow out of the second flow path 20b in the other branching flow path to circulate the air while heating the air conditioning device 10. By performing such a dehumidification-regeneration mode, the regeneration of the adsorbing portion of the air conditioning device 10 can be performed while dehumidifying the air from the vehicle interior or the vehicle exterior by the air conditioning device.

In the vehicle air conditioning system illustrated in FIG. 3, the operation mode of the heat pump cycle 80 can include a heating operation mode and a cooling operation mode. The operation mode of the heat pump cycle 80 can be selected depending on switch operations by the driver, temperature changes detected by various detection units, and the like.

The heating operation mode opens the shutoff valves 87a to 87d and closes the shutoff valves 87a, 87e and 87f, thereby forming a flow path such that the refrigerant sequentially flows through the compressor 84, the condenser 81, the expansion valve 35a, the outdoor heat exchanger 85 and the heat exchanger 83. It should be noted that, in FIG. 3, the flow path through which the refrigerant flows in this heating operation mode is shown by a thicker line.

In the heating operation mode, the refrigerant that has undergone the heat exchange by the outdoor heat exchanger 85 and the heat exchanger 83 is compressed by the compressor 84, and the refrigerant discharged from the compressor 84 is introduced into the condenser 81 to heat the air. When executing the air conditioning device 10 in the dehumidification-regeneration mode, as illustrated in FIG. 3, the dehumidification mode is executed in the air conditioning device 10 located in one branching flow path, and the regeneration mode is executed in the air conditioning device 10 located in the other branching flow path. In this case, the heat exchanger 83 located on the downstream side of the air conditioning device 10 that performs the regeneration mode can exchange heat between the air heated by the air conditioning device 10 and the refrigerant, thereby reducing the power consumption (compression ratio) of the compressor 84 and effectively utilizing the heat generated in the regeneration mode of the air conditioning device 10. It should be noted that in the heating operation mode, the temperature of the air flowing into the vehicle interior can be adjusted by controlling the opening degree of the air mix door 90.

The heating operation mode may open the shutoff valves 87a to 87c and close the shutoff valves 87d to 87f, thereby forming a flow path such that the refrigerant sequentially flows through the compressor 84, the condenser 81, the expansion valve 86a, and the outdoor heat exchanger 85. The refrigerant compressed by the compressor 84 enters the condenser 81 as a high-temperature, high-pressure refrigerant, exchanges heat with the air flowing through the first flow path 20a in the air conditioning duct 20, and releases the heat. The refrigerant that has left the condenser 81 is pressure-reduced and expanded by the expansion valve 86a to form a low-temperature, low-pressure refrigerant, and then exchanges the heat with the outside air in the outdoor heat exchanger 85 to absorb the heat, and returns to the compressor 84. When this heating operation mode is performed, the air flowing through the first flow path 20a in the air conditioning duct 20 is heated by the condenser 81, and the heated air flows into the vehicle interior. The temperature of the air flowing into the vehicle interior can be adjusted by controlling the opening degree of the air mix door 90. Although this heating operation mode may be performed when the execution mode of the air conditioning device 10 is the dehumidification mode or the dehumidification-regeneration mode, it is performed particularly when the execution mode is the dehumidification mode.

The cooling operation mode opens the shutoff valves 87a, 87e, 87f and closes the shutoff valves 87b to 87d, thereby forming a flow path such that the refrigerant sequentially flows through the compressor 84, the outdoor heat exchanger 85, the expansion valve 86b and the evaporator 82. The refrigerant compressed by the compressor 84 to a high temperature and a high pressure is cooled by exchanging heat with the outside air and releasing the heat in the outdoor heat exchanger 85. The refrigerant that has left the outdoor heat exchanger 85 is pressure-reduced and expanded by the expansion valve 86b to form a low-temperature, low-pressure refrigerant, which enters the evaporator 82, and exchanges the heat with the air flowing through the first flow path 20a in the air conditioning duct 20 to absorb the heat The refrigerant that has left the evaporator 82 returns to the compressor 84. When the cooling operation mode is performed, the air flowing through the first flow path 20a in the air conditioning duct 20 is cooled by the evaporator 82, and the cooled air flows into the vehicle interior. The cooling operation mode is particularly useful when it is desired to rapidly cool the vehicle interior (strong cooling operation mode). In addition, this cooling operation mode may be performed when the execution mode of the air conditioning device 10 is the dehumidification mode or the dehumidification-regeneration mode.

The cooling operation mode opens the shutoff valves 87a, 87c, 87f and closes the shutoff valves 87b, 87d and 87e, thereby forming a flow path such that the refrigerant sequentially flows through the compressor 84, the condenser 81, the expansion valve 86a, the outdoor heat exchanger 85 and the evaporator 82. The condenser 81 and the expansion valve 86a are further provided on a downstream side of the compressor 84 in the refrigerant flow path in this cooling operation mode. In the cooling operation mode, the cooling of the air by the evaporator 82 and the heating of the air by the condenser 81 can be adjusted by controlling the opening degree of the air mix door 90, so that the temperature of the air can be controlled to the optimum temperature.

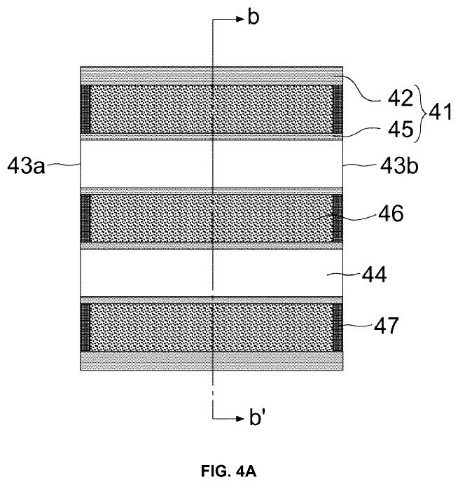

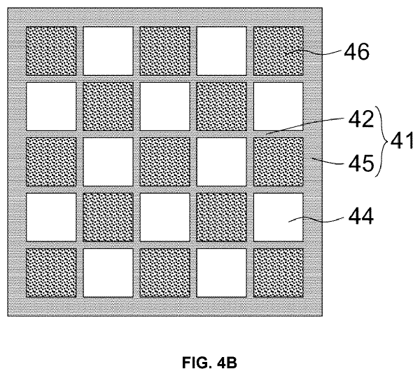

Next, FIG. 4A illustrates a schematic view of a cross section of the heat storage structure used as the waste heat recovery component 40, which is parallel to the flow direction of the heat storage structure. FIG. 4B illustrates a schematic view of the cross section of the heat storage structure taken along the line b-b′ in FIG. 4A.

The heat storage structure as illustrated in FIGS. 4A and 4B includes: a honeycomb structure 41 having an outer peripheral wall 42 and partition walls 45 disposed on an inner side of the outer peripheral wall 42, the partition walls 45 defining a plurality of cells 44 each extending from a first end face 43a to a second end face 43b of the honeycomb structure 41; and a heat storage material 46 contained in at least part of the cells 44.

The shapes of the honeycomb structure 41 and the cells 44 used in the thermal storage structure can be similar to the shape of the honeycomb structure 11 used in the air conditioning device 10.

The outer peripheral wall 42 preferably has a thickness larger than that of the partition wall 45. Such a structure can lead to increased strength of the outer peripheral wall 42 which would otherwise tend to generate breakage (e.g., cracking, chinking, and the like) due to external impact, thermal stress and the like.

The thickness of the outer wall 42 may preferably be more than 0.3 mm and 10 mm or less, more preferably 0.5 mm to 5 mm, and even more preferably 1 mm to 3 mm.

The thickness of the partition walls may preferably be 0.1 to 1 mm, and more preferably 0.2 to 0.6 mm. The thickness of the partition walls 45 of 0.1 mm or more can provide the honeycomb structure 41 with a sufficient mechanical strength. Further, the thickness of the partition wall 45 of 1 mm or less can prevent problems that the pressure loss is increased due to a decrease in an opening area and the heat recovery efficiency is decreased due to a decrease in a contact area with the air.

The outer peripheral wall 42 and the partition walls 45 contain ceramics as a main component.

The phrase “contain ceramics as a main component” as used herein means that a mass ratio of the ceramics to the total mass is 50% by mass or more.

Each of the outer peripheral wall 42 and the partition walls 45 preferably has a porosity of 10% or less, more preferably 5% or less, and even more preferably 3% or less, although not particularly limited thereto. The porosity of them may also be 0%. The porosity of them of 10% or less can lead to improvement of thermal conductivity.

The outer peripheral wall 42 and the partition walls 45 preferably contain SiC (silicon carbide) having high thermal conductivity as a main component.

As used herein, the phrase “contain SiC (silicon carbide) as a major component” means that a mass ratio of SiC (silicon carbide) to the total mass is 50% or more.

More specific examples of materials for the outer peripheral wall 42 and the partition walls 45 includes Si-impregnated SiC, (Si+Al) impregnated SiC, a metal composite SiC, recrystallized SiC, Si₃N₄, SiC, and the like. Among them, Si-impregnated SiC and (Si+Al)-impregnated SiC are preferably used because they can allow for production at lower cost and have high thermal conductivity.

A cell density (that is, the number of cells 44 per unit area) in the cross section of the honeycomb structure 41 that is orthogonal to the flow path direction of the air is not particularly limited and may be adjusted as needed, but it may preferably be in a range of from 4 to 320 cells/cm². The cell density of 4 cells/cm² or more can sufficiently ensure the strength of the partition walls 45, hence the strength of the honeycomb structure 41 itself and effective GSA (geometrical surface area). Further, the cell density of 320 cells/cm² or less can allow for prevention of an increase in a pressure loss when the air flows.

The honeycomb structure 41 preferably has an isostatic strength of more than 100 MP a or more, more preferably 150 MP a or more, and still more preferably 200 MPa or more, although not particularly limited thereto. The isostatic strength of the honeycomb structure 41 of more than 100 MP a can lead to the honeycomb structure 41 having improved durability. The isostatic strength of the honeycomb structure 41 can be measured according to the method for measuring isostatic fracture strength as defied in the J ASO standard M505-87 which is a motor vehicle standard issued by Society of Automotive Engineers of Japan, Inc.

The honeycomb structure 41 preferably has a thermal conductivity of 50 W/(m·K) or more at 25° C., more preferably from 100 to 300 W/(m·K), and even more preferably from 120 to 300 W/(m K), although not particularly limited thereto. The thermal conductivity of the honeycomb structure 41 in such a range can lead to an improved thermal conductivity and an improved heat recovery efficiency. It should be noted that the value of thermal conductivity is a value measured according to the laser flash method (JIS R 1611:1997).

The heat storage material 46 is maintained in some of the cells 44 of the honeycomb structure 41.

The method for maintaining the heat storage material 46 in the cells 44 is not particularly limited, and various methods may be used. For example, the heat storage material 46 may be applied and immobilized onto the partition walls 45 that define the cells 44, or the cells 44 may be filled with the heat storage material 46. When applying and immobilizing the heat storage material 46 onto the partition walls 45, a layer of the heat storage material 46 may be formed on the surface of each partition wall 45, and there may be portions where no heat storage material 46 is present in the central region of the cells 44. However, the heat storage material 46 may preferably be filled in the cells 44. By filling the cells 44 with the heat storage material 46, an amount of the heat storage material 46 maintained increases, so that a storage amount of heat recovered from the air can be increased.

The position of the cells 44 in which the heat storage material 46 is held in the honeycomb structure 41 is not particularly limited. For example, the heat storage material 46 may be held evenly in all the cells 44 of the honeycomb structure 41 in the cross section orthogonal to the extending direction of the cells 44, or the heat storage material 46 may be held intensively on the peripheral or central side of the honeycomb structure 41.

The cells 44 filled with the heat storage material 46 may preferably be plugged on the first end face 43a side and the second end face 43b side. In other words, the cells 44 filled with the heat storage material 46 may preferably have plugged portions 47 on the first end face 43a side and the second end face 43b side. Such a configuration can prevent the heat storage material 46 from falling out of the cells 44.

The plugged portions 47 may be made of any material that is not particularly limited, which may be same as the materials for the outer peripheral wall 42 and the partition wall 45. Resin sheets or other materials may also be used. The method for forming the plugged portions 47 is not particularly limited, but it may be performed according to a known method.

The heat storage material 46 is not particularly limited, and a known heat storage material can be used. For example, a latent heat storage material and/or a sensible heat storage material can be used as the heat storage material 46.

As used herein, the “latent heat storage material” means a heat storage material that stores heat using latent heat resulting from a phase change between solid and liquid, and the “sensible heat storage material” means a heat storage material that stores heat using a temperature change without a phase change.

The latent heat storage material and sensible heat storage material are not particularly limited, and any commercially available material can be used. Examples of the latent heat storage material include metallic PCMs (Phase Change Materials) such as Al-based alloys, Cu-based alloys, Fe-based alloys, and organic PCMs such as paraffin. Examples of the sensible heat storage material include ceramics. Since the latent heat storage material may flow out of the cells 44 due to the phase change, it is preferable that the honeycomb structure 41 be made of a material with low porosity or an encapsulated latent heat storage material be used.

The heat storage structure can be produced in accordance with the method as described below.

First, a green body containing ceramic powder is extruded into a desired shape to prepare a honeycomb formed body. At this time, the shape and density of the cells 44, and shapes and thicknesses of the outer peripheral wall 42 and the partition walls 45, and the like, can be controlled by selecting dies and jigs in appropriate forms. The material of the honeycomb formed body that can be used includes the ceramics as described above. For example, when producing a honeycomb formed body containing the Si-impregnated SiC composite as a main component, a binder and water and/or an organic solvent are added to a predetermined amount of SiC powder, and the resulting mixture is kneaded to form a green body, which can be then formed into a honeycomb formed body having a desired shape. The resulting honeycomb formed body can be then dried, and the honeycomb formed body can be impregnated with metallic Si and fired under reduced pressure in an inert gas or vacuum to obtain a honeycomb structure 41 having cells 44 defined by partition walls 45. The method for impregnation and firing of metal Si is to place the lump containing metal Si in contact with the honeycomb formed body and fire it.

The heat storage material 46 is then maintained in some of the cells 44 of the honeycomb structure 41. As a method for maintaining the heat storage material, the method described above can be used. When filling some of the cells 44 of the honeycomb structure 41 with the heat storage material 46, it is sufficient to form plugged portions 47 at one end portion of the cells 44 to be filled with the heat storage material 46, then fill them with the heat storage material 46 from the other end portion and form plugged portions 47 at the other end portion.

The vehicle air conditioning system including the heat storage structure as described above can recover the heat generated during the regeneration process of the air conditioning device 10 by the heat storage structure. The heat recovered in the thermal storage structure can be used by dissipating the heat by allowing the air to flow through the thermal storage structure during the heating operation.

### 5. Power Source 50

The power source 50 is for applying a voltage to the air conditioning device 10 (in particular, the pair of electrodes 17a, 17b). The power source 50 is electrically connected to the control unit 70, and adjusts the state of the voltage applied to the pair of electrodes 17a, 17b according to instructions from the control unit 70.

The power source 50 is not particularly limited, and a battery or the like can be used.

### 6. Ventilation Fan 60

The ventilation fan 60 is a device for allowing the air from the vehicle interior or the vehicle exterior to flow into the air conditioning device 10, and is provided in the air conditioning duct 20. The position of the ventilation fan 60 is not limited, but it may be on the upstream side of the air conditioning device 10, for example, as illustrated in FIG. 1 and the like, or on the downstream side of the air conditioning device 10.

The ventilation fan 60 is electrically connected to the control unit 70 and can control the flow velocity of the air by adjusting the rotation speed according to instructions from the control unit 70.

### 7. Control Unit 70

The control unit 70 controls the air conditioning device 10 and the valve 30. Further, the control unit 70 can also control the ventilation fan 60. Furthermore, if the waste heat recovery component 40 is the heat exchanger 83 of the heat pump cycle 80, the control unit 70 can also control the heat pump cycle 80. In particular, the control unit 70 is electrically connected to the shutoff valves 87a to 87f in the heat pump cycle 80, and can control the refrigerant flow path by opening and closing the shutoff valves 87a to 87f. Further, the control unit 70 is electrically connected to the expansion valves 86a, 86b in the heat pump cycle 80, and can control the degree of reduced pressure of the refrigerant by adjusting the opening degrees of the expansion valves 86a, 86b.

The control unit 70 is electrically connected to the air conditioning device 10 and the ventilator 60 via the power source 50. The control unit 70 can control the power source 50, thereby adjusting the heating state of the honeycomb structure 11 by controlling a voltage applying state to the pair of electrodes 17a, 17b of the air conditioning device 10. Further, the control unit 70 can also control the valve 30 so that the air flows through the first flow path 20a or the second flow path 20b. Furthermore, the control unit 70 can adjust the rotation speed of the ventilation fan 60, thereby controlling the flow velocity of the air flowing through the air conditioning duct 20.

The control unit 70 is generally an ECU (Engine (electronic) Control Unit), although not particularly limited thereto. The ECU is a CPU for executing various calculation processes, a ROM for storing programs and data required for its control, a RAM for temporarily storing results of calculations performed by the CPU, and input/output ports for inputting and outputting signals to and from the outside.

The control unit 70 can perform an air conditioning mode configured to switch the valve 30 so that the air flows into the first flow path 20a, and a regeneration mode configured to heat the air conditioning device 10 and switch the valve 30 so that the air flows into the second flow path 20b.

In the air conditioning mode, the moisture in the air circulating from the vehicle interior or vehicle exterior is adsorbed, and the air with reduced or removed moisture is returned to the vehicle interior through the first flow path 20a. In the regeneration mode, the moisture adsorbed in the adsorbing layer 16 is separated, and the heat is recovered by the waste heat recovery component 40, and then discharged through the second flow path 20b to the vehicle exterior.

From the viewpoint of stably performing the above control, it is desirable that the air conditioning device 10 be placed at a position close to the vehicle interior. Therefore, from the viewpoint of preventing electric shock and the like, it is preferable that the driving voltage of the air conditioning device 10 is 60V or less. Since the honeycomb structure 11 used in the air conditioning device 10 has a low electrical resistance at room temperature, the honeycomb structure 11 can be heated at the low driving voltage. It should be noted that the lower limit of the driving voltage is not particularly limited, but it may preferably be 10 V or more. If the driving voltage is less than 10V, the current during heating the honeycomb structure 11 becomes large, so that the conductor wire should be thick.

### EXAMPLES

Hereinafter, the disclosure will be more specifically described with reference to Examples, but the disclosure is not limited to these Examples.

### Production of Air Conditioning Device

As ceramic raw materials were prepared BaCO₃ powder, TiO₂ powder, and La(NH₃)₃·6H₂O powder. These powders were weighed to have the required composition after firing, and dry-mixed to obtain a mixed powder. The dry mixing was performed for 30 minutes. To 100 parts by mass of the resulting mixed powder were then added water, a binder, a plasticizer, and a dispersant by an appropriate amount in the range of 3 to 30 parts by mass in total so as to obtain a ceramic formed body having a relative density of 64.8% after extrusion, and then kneaded to obtain a green body. Methylcellulose was used as the binder. Polyoxyalkylene alkyl ethers were used as the plasticizer and the dispersant.

The resulting green body was then fed into an extrusion molding machine and extruded using a predetermined die to form a honeycomb structure having the shape illustrated below after firing.
Shape of cross section and end face of honeycomb structure orthogonal to flow path direction: quadrangular;
Shape of cross section of cells orthogonal to flow path direction: quadrangular;
Thickness of partition wall: 0.13 mm;
Thickness of outer peripheral wall: 0.2 mm;
Cell density: 80 cells/cm²;
Cell pitch: 1.1 mm;
Cross-sectional area of honeycomb structure orthogonal to flow path direction: 10000 mm²;
Length of honeycomb structure in flow path direction: 10 mm;
Volume resistivity of materials comprised of outer peripheral wall and partition wall at 25° C.: 15 Ω·cm; and
Curie point of material making up outer peripheral wall and partition wall: 110° C.

Subsequently, the resulting honeycomb structure was subjected to dielectric drying and hot air drying, and then degreased (450° C. for 4 hours) in a sintering furnace in an air atmosphere, and then sintered in an air atmosphere. The firing was performed by maintaining the honeycomb structure at a temperature of 950° C. for 1 hour, then increasing the temperature to 1200° C. and maintaining it at 1200° C. for 1 hour, and then increasing the temperature to 1400° C. (maximum temperature) at a rate of 200° C./hour and maintaining it at a temperature of 1400° C. for 2 hours.

The pair of electrodes were formed on both end faces (first end face and second end face) of the resulting honeycomb structure. First, an electrode slurry containing aluminum (electrode material), ethyl cellulose and diethylene glycol monobutyl ether (organic binder) was prepared and applied to the first end face, and the electrode slurry was then dried to form an electrode on the first end face. Using the same electrode slurry, an electrode was formed on the second end face by applying the electrode slurry to the second end face and drying it

The honeycomb structure with a pair of electrodes was then immersed in a slurry containing zeolite (adsorbent), an inorganic binder, and water, and the slurry adhering to excess positions (such as the periphery) was removed by blowing and wiping, and then dried at about 550° C. to form an adsorbing layer having a thickness of 150 μm on surfaces of the partition walls and on a surface of the outer peripheral wall facing the cells.

The air conditioning device and the waste heat recovery component obtained as described above were placed in the air conditioning duct at the distance illustrated in Table 1 to construct the vehicle air conditioning system illustrated in FIG. 1. The waste heat recovery component was a heat exchanger through which a fluid flowed, and was provided throughout the entire flow path cross section of the air conditioning duct. The inner circumferential length of the cross section of the air conditioning duct (at a portion where the air conditioning device was provided) was 46 cm, and the inner circumferential length of the cross section of each of the first and second flow paths was 23 cm.

This vehicle air conditioning system was subjected to the moisture adsorption process by the air conditioning device, followed by regeneration process, and the adhesion of condensed water to the air conditioning device and the heat recovery efficiency of the heat exchanger were evaluated.

The moisture adsorption process was performed by starting the ventilator and allowing the air at a temperature of 25° C. and at relative humidity of 40% to flow at a flow rate of 1.00 m/s into the air conditioning duct for 3 minutes. The regeneration process of the air conditioning device was performed by allowing the air at a temperature of 25° C. and at relative humidity of 40% to flow at a flow rate of 0.1 m/s for 3 minutes while applying a voltage of 12 V to the air conditioning device from a DC power source unit.

The adhesion of the condensed water to the air conditioning device was evaluated by the electrical resistance between the electrodes in the air conditioning device.

The current values flowing between the electrodes in the HVAC device at the beginning and at the end of the regeneration process were measured, and the electrical resistance between the electrodes was calculated. The rate of increase in electrical resistance at the end of the regeneration process relative to the electrical resistance at the beginning of the regeneration process was then determined.

In this evaluation, a case where a rate of increase in electrical resistance was less than 10% is represented as A (very good), a case where a rate of increase in electrical resistance was 10% or more and less than 20% is represented as B (good), a case where a rate of increase in electrical resistance was 20% or more and less than 30% is represented as C (acceptable), and a case where a rate of increase in electrical resistance was 30% or more is represented as D (poor).

The heat recovery efficiency of the heat exchanger was calculated by the following equation:

$$Heat recovery efficiency [ \% ] = recovered heat quantity [ W ] / heat input [ W ]$$

In the equation, the recovered heat quantity and heat input were determined by the following equation:

$$Recovered heat quantity [ W ] = ( fluid temperature at outlet side of heat exchanger [ ° C . ] - fluid temperature at inlet side of heat exchanger [ ° C . ] ) \times fluid flow rate [ kg / s ] \times specific heat of fluid [ J / kg ° C . ] )$$

$$Heat input [ W ] = ( air temperature before entering heat exchanger [ ° C . ] - fluid temperature at inlet side of heat exchanger [ ° C . ] ) \times air flow rate [ kg / s ] \times specific heat of air [ J / kg ° C . ]$$

In this evaluation, a case where the heat recovery efficiency was 70% or more is represented as A (very good), a case where the heat recovery efficiency was 60% or more and less than 70% is represented as B (good), a case where the heat recovery efficiency was 50% or more and less than 60% is represented as C (acceptable), and a case where the heat recovery efficiency was less than 50% is represented as D (poor).

The above results are shown in Table 1.

TABLE 1

| | Distance between Air | Rate of | | |
|---|---|---|---|---|
| | Conditioning Device and | Increase in | Heat | |
| Test | Waste Heat Recovery | Electrical | Recovery | |
| Nos. | Component [mm] | Resistance | Efficiency | Classification |
| 1 | 3 | D | A | Comp. |
| 2 | 5 | C | A | Ex. |
| 3 | 8 | B | B | Ex. |
| 4 | 190 | B | B | Ex. |
| 5 | 200 | A | C | Ex. |
| 6 | 220 | A | D | Comp. |

As illustrated in Table 1, the distance between the air conditioning device and the heat exchanger (waste heat recovery component) was in the range of 5 to 200 mm, thereby increasing the heat recovery efficiency of the heat exchanger while suppressing adhesion of the condensed water onto the air conditioning device. In contrast, when the distance between the air conditioning device and the heat exchanger was less than 5 mm, the condensed water could not be prevented from adhering to the air conditioning device. When the distance between the air conditioning device and the heat exchanger exceeded 200 mm, the heat recovery efficiency of the heat exchanger decreased.

As can be seen from the above results, according to the disclosure, it is possible to provide a vehicle air conditioning system that can prevent the condensed water from adhering to the air conditioning device while improving the recovery efficiency of the heat generated during the regeneration process of the air conditioning device.

### DESCRIPTION OF REFERENCE NUMERALS

10 air conditioning device
11 honeycomb structure
12 outer peripheral wall
13a first end face
13b second end face
14 cell
15 partition wall
16 adsorbing layer
17a, 17b pair of electrodes
18 terminal
20 air conditioning duct
20a first flow path
20b second flow path
30 valve
40 waste heat recovery component
41 honeycomb structure
42 outer peripheral wall
43a first end face
43b second end face
44 cell
45 partition wall
46 heat storage material
47 plugged portion
50 power source
60 ventilation fan
70 control unit
80 heat pump cycle
81 condenser
82 evaporator
83 heat exchanger
84 compressor
85 outdoor heat exchanger
90 air mix door

1. A vehicle air conditioning system, comprising:
at least one air conditioning device comprising an adsorption portion having an adsorbent configured to adsorb and separate moisture, and a heating means configured to heat the adsorption portion;
an air conditioning duct for allowing air from a vehicle interior or a vehicle exterior to flow therethrough, the air conditioning duct having the air conditioning device provided therein, wherein the air conditioning duct has a first flow path for allowing the air to flow into the vehicle interior on a downstream side of the air conditioning device and a second flow path for discharging the air to the vehicle exterior;
a valve configured to switch the flow of the air between the first flow path and the second flow path; and
at least one waste heat recovery component provided between the air conditioning device and the valve,
wherein a distance between the air conditioning device and the waste heat recovery component is 5 to 200 mm.

2. The vehicle air conditioning system according to claim 1, wherein the distance between the air conditioning device and the waste heat recovery component is 8 to 190 mm.

3. The vehicle air conditioning system according to claim 1, wherein the waste heat recovery component is provided over the entire flow path cross section of the air conditioning duct

4. The vehicle air conditioning system according to claim 1, wherein the vehicle air conditioning system further comprises a heat pump cycle in the first flow path, the heat pump cycle comprising: a condenser for exchanging heat between warm heat of a refrigerant and the air; and an evaporator for exchanging heat between cold heat of the refrigerant and the air, and the waste heat recovery component is a heat exchanger that exchanges heat between the heat of the refrigerant in the heat pump cycle and the air flowing through the second flow path.

5. The vehicle air conditioning system according to claim 1, wherein the waste heat recovery component is a heat storage structure, the heat storage structure comprising a honeycomb structure having: an outer peripheral wall and partition walls provided on an inner side of the outer peripheral wall, the partition walls defining a plurality of cells, each of the cells extending from a first end face to a second end face to the honeycomb structure; and a heat storage material contained in at least part of the cells.

6. The vehicle air conditioning system according to claim 1, wherein the adsorbent is configured to adsorb and separate at least one of carbon dioxide and volatile components.

7. The vehicle air conditioning system according to claim 1, wherein the air conditioning device comprises:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air;
an adsorbing layer comprising the adsorbent, the adsorbing layer being provided on a surface of each of the partition walls; and
a pair of electrodes provided on the first end face and the second end face of the honeycomb structure, or on the outer peripheral wall parallel to the extending direction of the cells of the honeycomb structure.

8. The vehicle air conditioning system according to claim 7, further comprising a power source for applying a voltage to the pair of electrodes.

9. The vehicle air conditioning system according to claim 7, wherein at least the partition walls of the honeycomb structure are made of a material having a positive temperature coefficient (PTC) property.

10. The vehicle air conditioning system according to claim 1, further comprising a control unit for controlling the air conditioning device and the valve,
wherein the control unit is configured to perform an air conditioning mode configured to switch the valve so that the air flows into the first flow path, and a regeneration mode configured to heat the air conditioning device and switch the valve so that the air flows into the second flow path.
